(19) United States
(12) Patent Application Publication
(10) Pub. No.: US 2026/0326647 A1
(43) Pub. Date: Oct. 22, 2026

(54) DYNAMIC AND FLEXIBLE ARTICLE HOLDER SYSTEM

(71) Applicant: GM GLOBAL TECHNOLOGY OPERATIONS LLC, Detroit, MI (US)

(72) Inventors: Eleodoro Pacheco, JR., Eastpointe, MI (US); Keith A. Fisher, Rochester, MI (US); Pritam Mohan Prabhu, Rochester Hills, MI (US); Devon Robert Stout, Farmington Hills, MI (US)

(73) Assignee: GM GLOBAL TECHNOLOGY OPERATIONS LLC, Detroit, MI (US)

(21) Appl. No.: 19/181,669

(22) Filed: Apr. 17, 2025

(51) Int. Cl. B60N 3/10

(52) U.S. Cl. CPC B60N 3/103; B60N 3/106

(57) ABSTRACT

A dynamic and flexible holder system for placing articles in a stable and supported condition. In a number of embodiments, an article holder system includes an enclosure defining, at least in part, a compartment to hold articles. A divider defines and separates a first place from a second place within the compartment. A rail system includes at least one rail defined on the enclosure. A housing is coupled between the divider and the rail system. A spring is carried by the housing. The spring includes a section that projects toward the rail. The rail includes notches that receive the section of the spring to hold the divider in a latched state and the divider includes an aperture that operates to move the section of the spring to unlatch the divider.

### INTRODUCTION

The technical field generally relates to systems for holders of articles, and more particularly relates to a dynamic and flexible holder system for placing articles in a stable and supported condition for applications where stowability and flexibility of use may be desirable.

Article holders may be used for various purposes and may be adapted to hold personal articles of a user. Article holders may be used to securely hold an article that the user does not want moving around or falling. Article holders may also be used to organize items in an ordered fashion and in an appropriate place. One application of article holders is a cupholder, which may be found in locations frequented by humans, particularly when seated. Chairs, bleachers, theater seating, vehicle seats, tables, trays and other places often include cupholders and other article holders.

Many locations where convenient access to an article holder is desirable are found in mobile platforms such as various types of vehicles. Other applications may be stationary, such as in buildings and at outside venues. Locations may include those accessible to the public and may also include private places. In addition to being readily accessible, article holders are desirably secure and are preferably unobtrusive when not in use. Because of the potential frequency and variation of their use, holder systems are preferably easily adapted to hold articles of various sizes and shapes.

Accordingly, there is a desire to provide article holders that are flexible and may be conveniently used in a variety of locations and for various applications. There is also a desire to provide easy adjustability for flexible holding and/or storage. Furthermore, other desirable features and characteristics of the present disclosure will become apparent from the subsequent detailed description and the appended claims, taken in conjunction with the accompanying drawings and the foregoing introduction.

### SUMMARY

A dynamic and flexible holder system for placing articles in a stable and supported condition is provided. In a number of embodiments, an article holder system includes an enclosure defining, at least in part, a compartment to hold articles. A divider defines and separates a first place from a second place within the compartment. A rail system includes at least one rail defined on the enclosure. A housing is coupled between the divider and the rail system. A spring is carried by the housing. The spring includes a section that projects toward the rail. The rail includes notches that receive the section of the spring to hold the divider in a latched state and the divider includes an aperture that operates to move the section of the spring to unlatch the divider.

In additional embodiments, there are two rails, both of which include the notches.

In additional embodiments, the divider operates to move a travel distance relative to the housing. The travel distance is approximately equal to an unlatch distance required to move the section out of a respective one of the notches.

In additional embodiments, there are four rails, two of which include the notches and two of which do not include the notches.

In additional embodiments, the housing includes spring seats The spring extends between the spring seats and the section of the spring is disposed between the spring seats.

In additional embodiments, the section of the spring has a projection that extends toward the rail.

In additional embodiments, the divider moves a travel distance relative to the housing. The travel distance is approximately equal to an unlatch distance required to move the section out of one of the notches. The aperture has a profile that defines the unlatch distance.

In additional embodiments, the rail system, the housing and the spring operate so that the divider is unlatched upon an application of force to the divider and the divider is self-latching upon a cessation of the application of force.

In additional embodiments, the housing has an I-shaped bar with a section coupling with the divider and a section coupling with the at least one rail.

In additional embodiments, the enclosure is a removeable insert received in an interior component of a vehicle.

In a number of additional embodiments, an article holder system includes an enclosure defining a compartment that holds articles. A divider defines and separates a first place from a second place within the compartment. A rail system includes a first rail and a second rail, the first and second rails defined on the enclosure. A first housing is coupled between the divider and the first rail. A second housing coupled between the divider and the second rail. A first spring is carried by the first housing and includes a first section projecting toward the first rail. A second spring is carried by the second housing and includes a second section projecting toward the second rail. The first rail includes first notches receiving the first section and the second rail each includes second notches receiving the second section to hold the divider in a latched state. The divider includes a first aperture that moves the first section and a second aperture that moves the second section to unlatch the divider for repositioning.

In additional embodiments, the divider moves a travel distance relative to the first and second housings. The travel distance is approximately equal to an unlatch distance required to move the first section out of the first notches and the second section out of the second notches.

In additional embodiments, the rail system includes the first rail, the second rail, a third rail and a fourth rail. The third and fourth rails do not include notches.

In additional embodiments, the first housing includes a first spring seat and a second spring seat. The first spring extends between the first spring seat and the second spring seat. The first section of the first spring is disposed between the first spring seat and the second spring seat.

In additional embodiments, the first section of the first spring has a first projection that extends toward the first rail and the second section of the second spring includes a second projection that extends toward the second rail.

In additional embodiments, the divider moves a travel distance relative to the first housing and the second housing. The travel distance is approximately equal to an unlatch distance required to move the first section out of the first notches and the second section out of the second notches. The first and second apertures each have a profile that defines the unlatch distance.

In additional embodiments, the rail system, the first and second housings and the first and second springs operate so that the divider is unlatched upon an application of force to the divider and the divider is self-latching upon a cessation of the application of force.

In additional embodiments, each of the first and second housings has an I-shaped bar with a first section coupling with the divider and a second section coupling with a respective one of the first and second rails.

In additional embodiments, the enclosure is a removeable insert received in a console of a vehicle and operates as a cupholder.

In a number of other embodiments, an article holder system for a vehicle includes an enclosure defining a compartment operable to hold articles. A divider defines and separates a first place from a second place within the compartment. A rail system includes a first rail and a second rail, each defined on the enclosure. A first housing is coupled between the divider and the first rail. A second housing is coupled between the divider and the second rail. A first spring is carried by the first housing and includes a first section that projects toward the first rail. A second spring is carried by the second housing and includes a second section that projects toward the second rail. The first rail includes first notches that receive the first section and the second rail each includes second notches that receive the second section to hold the divider in a latched state. The divider includes a first aperture operating to move the first section and a second aperture operating to move the second section to unlatch the divider for repositioning. The enclosure is a part of an interior component of the vehicle.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic illustration of an environment in the form of a vehicle that includes an article holder system, in accordance with various embodiments;

FIG. 2 is a perspective illustration of the article holder of the vehicle of FIG. 1 in isolation, in accordance with various embodiments;

FIG. 3 is a plan view illustration of the article holder of FIG. 2 in a first state, in accordance with various embodiments;

FIG. 4 is a plan view illustration of the article holder of FIG. 2 in a second state, in accordance with various embodiments;

FIG. 5 is a sectional illustration of the article holder of FIG. 2, in accordance with various embodiments;

FIG. 6 is a schematic illustration of certain parts of the article holder of FIG. 2, in accordance with various embodiments;

FIG. 7 is a schematic illustration of the latch area of the article holder of FIG. 2 in a latched state, in accordance with various embodiments;

FIG. 8 is a schematic illustration of the latch area of the article holder of FIG. 2 demonstrating limited travel between a divider and a spring housing, in accordance with various embodiments;

FIG. 9 is a schematic, sectional illustration of a spring housing area of the article holder of FIG. 2, in accordance with various embodiments;

FIG. 10 is a schematic illustration of the latch area of the article holder of FIG. 2 in a latched state, in accordance with various embodiments;

FIG. 11 is a schematic illustration of the latch area of the article holder of FIG. 2 in the process of being unlatched, in accordance with various embodiments;

FIG. 12 is a schematic illustration of the latch area of the article holder of FIG. 2 in an unlatched state, in accordance with various embodiments; and

FIG. 13 is a schematic illustration of a spring housing area of the article holder of FIG. 2 in an unlatched state, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding introduction or the following detailed description.

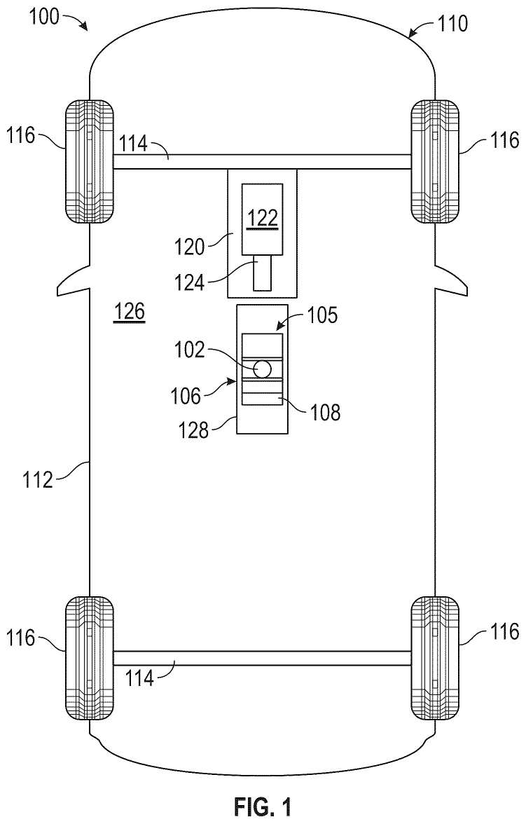

Referring to FIG. 1, illustrated is an environment 100 where a user may possess an article 102 that they would like to place in a secure location. For example, the location may be a compartment 104 that is defined by an enclosure 105 that is operable to securely hold various articles, such as the article 102. The enclosure 105 is a structure that defines the compartment 104. The compartment 104 is operable to hold various articles via an article holder system 106 that is dynamic by being quickly and easily adjusted, and is flexible to hold a variety of different sized and shaped articles/objects.

In the current embodiment of FIG. 1, the environment 100 is a vehicle 110. In other embodiments, the environment 100 may be any indoor or outdoor venue, whether mobile or stationary, where article holding is desired. In the current embodiment, the compartment 104 is an article holder, such as a multipurpose cup/article holder, received in an interior component 128, in this example a console of the vehicle 110. In other embodiments, the compartment 104, as defined by the enclosure 105 may be a bin, a box, a tray, a case, a container, or another defined space within or on which an article may be placed for holding. The compartment 104 may have a door 108 that is openable to reveal the inside and closable to conceal the inside of the compartment, as desired

In embodiments, the vehicle 110 may be any one of a number of different types of land, sea, or air vehicles, and in certain embodiments, may for example, be a passenger automobile of any configuration. For example, the vehicle 110 may be any one of a number of different types of automobiles, such as, for example, a sedan, a wagon, a truck, or a sport utility vehicle, and may be two-wheel drive (i.e., rear-wheel drive or front-wheel drive), four-wheel drive, or all-wheel drive. While the article holder system 106 may be described within an embodiment of the vehicle 110, it is not limited to that embodiment but has application in a number of settings including in any environment 100 where holding/storage of articles is desirable.

As depicted in FIG. 1, the vehicle 110 includes a body 112 arranged on, or integrated with, a chassis which may form a part of the body 112. In general, the body 112 houses the components of the vehicle 110 including the article holder system 106. The body 112 is connected with front and rear axles 114, such as through chassis elements (not shown). The axles 114 are connected with wheels 116 upon which the vehicle 110 rolls. Any number of the wheels 116 may be coupled with a propulsion system 120 to propel the vehicle 110.

The propulsion system 120 includes a prime mover 122 such as an engine and/or a motor. In the embodiment illustrated in FIG. 1, the propulsion system 120 supplies torque to drive the wheels 116 through a driveline that includes a transmission 124. In various embodiments, the transmission 124 may be configured to couple the front wheels 116 with the propulsion system 120 through the front axle 114. In other embodiments the transmission may be configured to couple the rear wheels 116 through the rear axle 114.

The vehicle 110 includes an interior 126 defined by the body 112 and lined with, or including, a number of interior components 128 that may be functional and/or aesthetic. The interior components 128 may include a dash, seats, armrests, door panels, a headliner, video systems, instruments, trim components, compartments, consoles, floor coverings, trays, holder, etc. The article holder system 106 may be based in or on any of the interior components 128 of the vehicle 110. In some embodiments, the article holder system 106 may be based in a dedicated interior component 128, such as a dedicated case or housing.

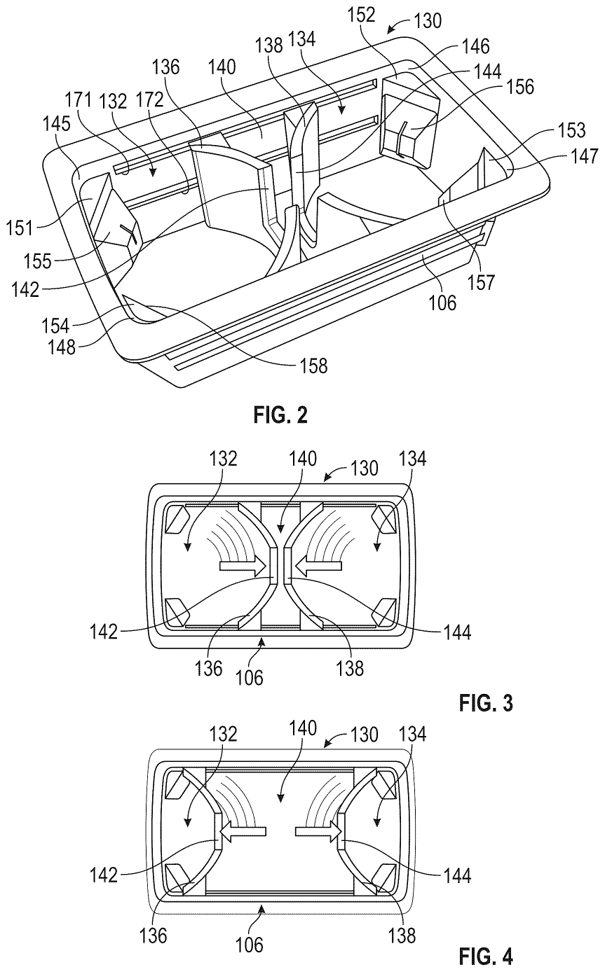

Referring to FIG. 2, shown is an insert 130 removed from the vehicle 110 for simplicity. The insert 130 is a part of, or defines, the compartment 104 and need not be separate from the enclosure 105 but may be an integral part thereof. Accordingly, the insert 130 includes features that may be a part of the enclosure 105 itself rather than as a separate component as shown. The insert 130 is configured with the article holder system 106 and in this example is operable as a cupholder and also as a holder of other articles such as a smartphone or tablet.

The article holder system 106 and specifically the insert 130 has two places 132 and 134 that are variably sized and are defined by dividers 136 and 138 that are shaped to accept generally cylindrical articles such as cups, bottles and cans of various sizes, and which may hold other articles. As shown in FIG. 3, the dividers 136 and 138 are positioned for accepting the aforementioned types of articles. The insert 130 also includes a place 140 between or across the dividers 136 and 138. The place 140 is enhanced by features of the dividers 136 and 138 so that various articles such as a generally rectangular smartphone or tablet may be supported. These features include openings 142 and 144 in the dividers 136 and 138 respectively. The openings 142 and 144 are slot like receptacles that also provide clearance for features such as cup handles. The openings 142 and 144 also enable utilizing all three places 132, 134 and 140 simultaneously for larger articles. As shown in FIG. 4, the dividers 136 and 138 are repositioned and spread apart opening the place 140 for larger articles. Larger articles are also are allowed to extend across the place 140, through the openings 142 and 144 and into the places 132 and 134.

The enclosure 105 via the insert 130 may include additional features to assist in holding various articles. For example, the corners 145-148 have fillets 151-154 that extend part way along the corners 145-148 with ledges at their top. A finger 155-158 is included on the side of each fillet 151-158, respectively. The fingers 155-158 are so-called because they present into the places 132 and 134 and have compliance for receiving and applying forces to inserted articles. In examples, the fingers 155-158 may be spring backed or may be made of a compressible structure and/or material. For example, the fingers 155-158 may be made of an elastic shell backed by air or may be a solid elastic material.

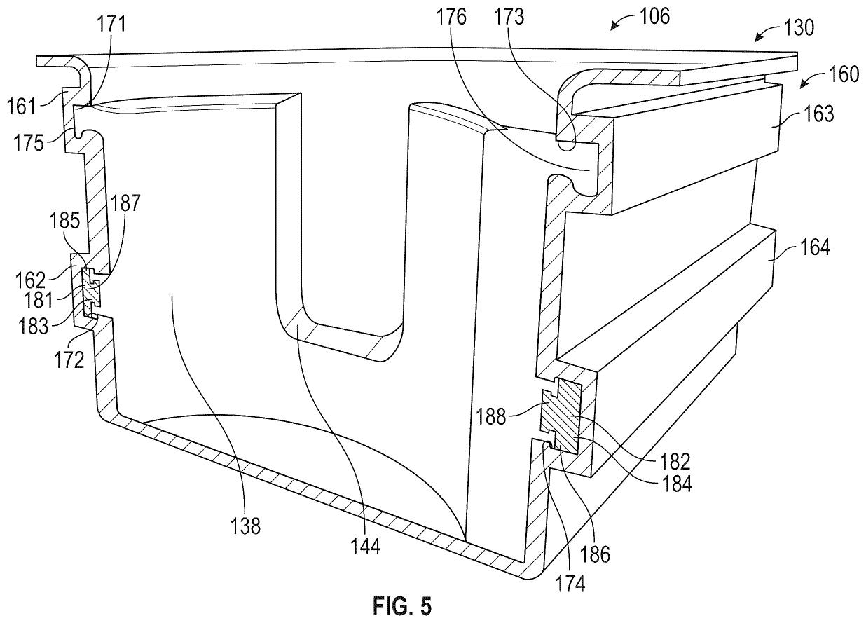

Referring additionally to FIG. 5, a section through the insert 130 at the divider 138 shows aspects of the article holder system 106. It will be appreciated that the area of the divider 136 is similarly constructed. The insert 130 has a rail system 160 with four rails 161-164. The rails 161-164 may be molded-in parts of the insert 130 or may be separate attached components. Each of the rails 161-164 is an elongated, generally rectangular receptacle opening into the places 132, 134 and 140 via slots 171-74, respectively. The slots 171 and 172 are also visible in FIG. 2. When the dividers 136 and 138 are repositioned they are guided by the rails 161-164, and generally slide along the slots 171-174.

The upper slots 171 and 173 open into the rails 161 and 163 respectively, to cross sections with L-shaped open interiors. Accordingly, the rails 161 and 163 are a type of L-slotted rails. The divider 138 has a pair of similarly L-shaped bars 175 and 176 that extend to slidably extend through the slots 171 and 173 and fit in the rails 161 and 163. The bars 175 and 176 generally extend through the slots 171 and 173 and hook into the rails 161 and 163 to support and guide the dividers 136 and 138.

In embodiments, the upper slots 171 and 173 provide stability to the dividers 136 and 178 as they slide for adjustment. In other embodiments, sufficient stability may be achieved with a single slot on each side. For example, the upper slots 171 and 173 and the corresponding bars 175 and 176 and the rails 161 and 163 may be omitted, such as for efficiency and simplicity. In such an embodiment, the slots 172 and 174 along with their corresponding rails 162 and 164 remain.

The lower slots 172 and 174 open into the rails 162 and 164 respectively, to cross sections with T-shaped open interiors. Accordingly, the rails 162 and 164 are a type of T-slotted rails. In this case, the divider 138 does not simply have T-shaped bars but includes aspects of the article holder system 106 that enable convenient and secure repositioning of the dividers 136 and 138. This includes housings 181 and 182 that interface between the divider 138 and the rails 162 and 164, respectively. The housings 181 and 182 include I-shaped bars 183 and 184 that include sections 185 and 186 that couple with the insert 130 at the rails 162 and 164 and that extend to slidably extend through the slots 172 and 174. In this example, the flange parts of the I-shape are not equal in length, but in other embodiments they may be. The bars 183 and 184 include the sections 185 and 186 that generally hook through the slots 172 and 174 and into the rails 162 and 164 to support and guide the dividers 136 and 138. The bars 183 and 184 also include sections 187 and 188 that hook into the divider 138 in a receiving T-shaped opening. Accordingly, the divider 138 and the housings 181 and 182 generally slide along the rails 162 and 164 together during repositioning, with some lost motion between them as described below.

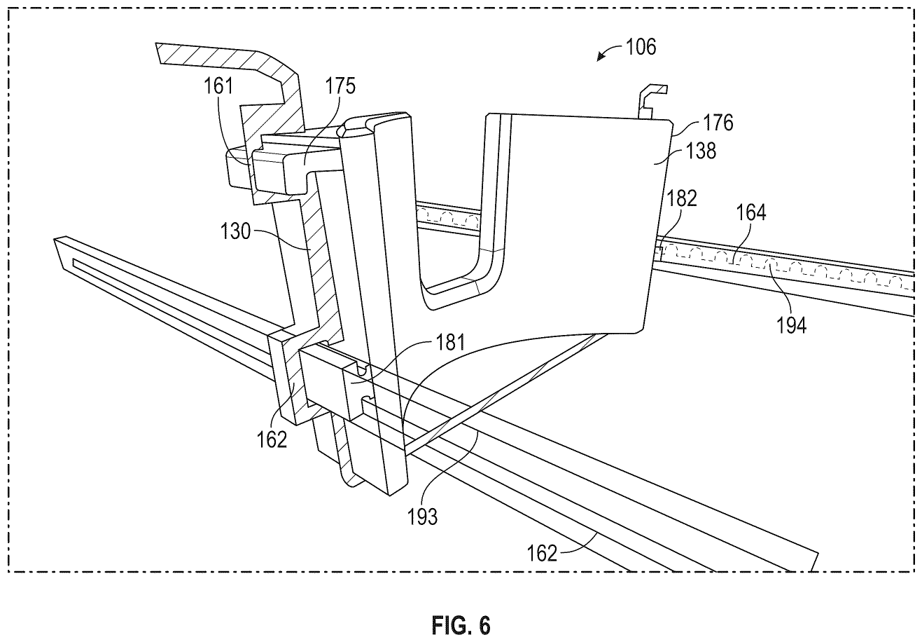

Referring additionally to FIG. 6, the rails 162 and 164 include notches 193 and 194, respectively along, or substantially along, their length. The notches 193 and 194 are each presented in series along their respective rails 162 and 164 and open toward the housings 181 and 182. In this example and as illustrated, the notches 193 and 194 in each series open downward and are in the tops of the rails 162 and 164. In other orientations or examples, the notches 193 and 194 in each series may open in other directions. The notches 193 and 194 effectively provide a rack-like function enabling the dividers 136 and 138 to be locked into desired locations for the size and shape of the article(s) to be held.

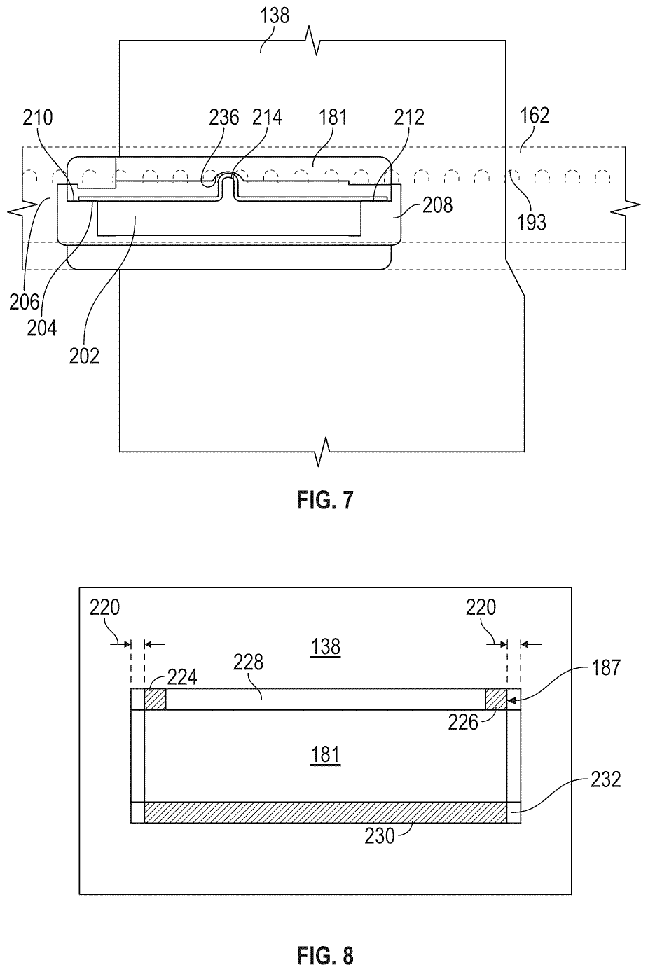

Referring additionally to FIG. 7, the area of the housing 181 is illustrated in a latched state. In the latched state, the divider 138 is held in position, which may also be referred to as a locked state. The housing 181 is disposed along the rail 162 and the notches 193 are visible. The housing 181 includes a cavity 202 and contains a spring 204. The spring 204 extends between two spring supports 206 and 208 on opposite ends of the housing 181. The spring 204 is in the form of a kind of leaf spring with one leaf made of a flexible material such as spring steel or another metal, or a polymer or composite, that is supported at each of its ends. Accordingly, the middle of the spring 204 is elastically deflectable. The ends of the spring 204 are supported in seats 210 and 212 of the supports 206 and 208. In other embodiments, another type of spring or springy material may be used as a biasing element. The middle of the spring 204 includes a section 214 that is generally Ω-shaped or upside down U-shaped forming a projection that provides a type of pawl or detent that acts to lock and unlock movement of the divider 138 bi-directionally. In embodiments, the section 214 may be referred to as pawl section 214. In FIG. 7, the spring 204 may be slightly flexed so that the section 214 remains in an aligned notch 193. The section 214 is also disposed in an unlatching aperture 236 of the divider 138, which is further described below.

Referring to FIG. 8, the housing 181 and a part of the divider 138 are shown in schematic form. The divider 138, as coupled with the housing 181, has a limited amount of travel distance 220 (lost motion) relative to the housing 181 and in each direction. The travel distance 220 is approximately equal to (≥) an unlatch distance required to move the section 214 out of a notch 193. It may also be said that the housing 181 and the divider 138 may travel relative to each other for the travel distance 220 to unlatch the divider 138 but also a minimized amount to unlatch the divider 138 without excessive movement. Accordingly, when force is applied to the divider 138 for repositioning in either direction, the divider 138 first moves the travel distance 220 before the housing 181 moves. During repositioning, after the divider 138 is moved the travel distance 220, the divider 138 and the housing 181 move along the rail 163 together.

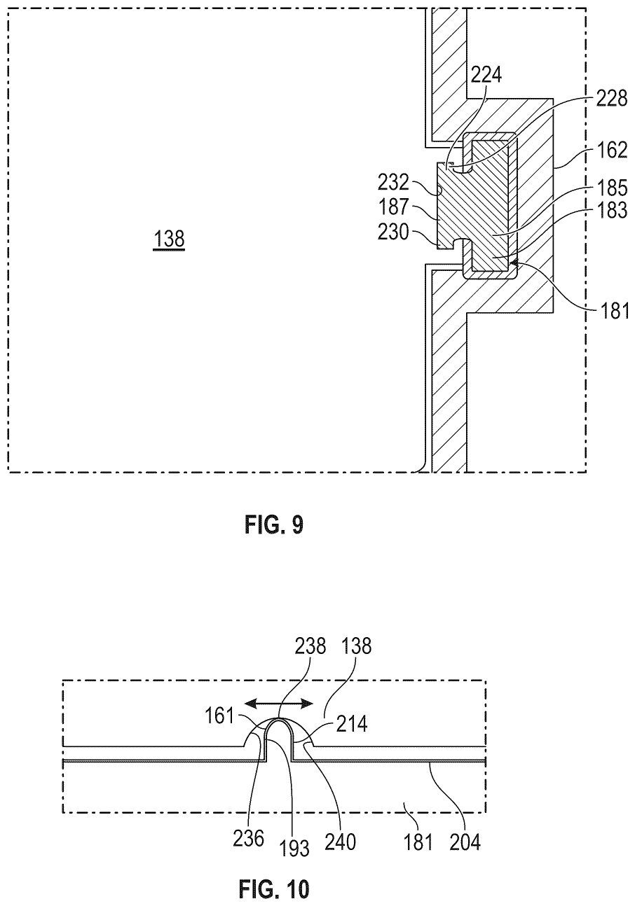

Referring to FIG. 9 along with FIG. 8, aspects including those providing the lost motion are shown. In FIG. 9, the I-shaped bar 183 of the housing 181 has the flange formed by the section 187 that couples with the divider 138 and the flange formed by the section 185 that couples with the rail 162. The flange of the section 187 is shorter/smaller than the flange of the section 185. Shown in FIG. 8, the top (as viewed) of the flange of the section 187 is made up of a pair of L-shaped fingers 224 and 226 that are received in a track 228 of the divider 138. The finger 224 and the track 228 are also visible in FIG. 9. The bottom (as viewed) of the flange of the section 187 is an L-shaped bar 230 that extends along the length of the housing 181 and is received in a track 232 of the divider 138. As seen in FIG. 8, the travel distance 220 is defined by the tracks 228 and 232 being longer than the outside dimension of the fingers 224, 226 and longer than the length of the bar 230. Accordingly, the divider 138 is movable the travel distance 220 relative to the housing 181 and the movement is limited to the travel distance 220.

The travel distance 220 works in both directions and is demonstrated by FIGS. 10-12 in one of those directions. In FIG. 10, the section 214 (inverted U-shaped or Ω-shaped) is positioned in the unlatching aperture 236 of the divider 138. The section 214 of the spring 204 is also aligned with, and disposed in, a notch 193 of the rail 161 which allows seating and centering within the unlatching aperture 236. To unlatch the divider 138 by moving the section 214 out of the notch 193, a force 238 on the divider 138 (which may be applied in either direction depending on the desired repositioning of the divider 138) moves the divider 138, via the unlatching aperture 236 to flex/compress the spring 204.

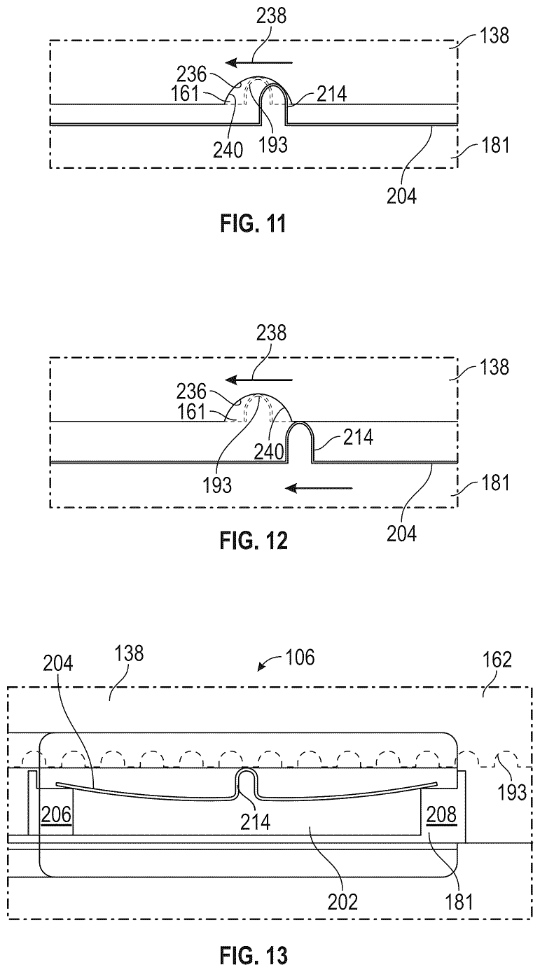

As shown in FIG. 11, the force 238 is applied to the left as viewed and the divider 138 moves relative to the housing 181, which remains stationary. The profile 240 of the unlatching aperture 236 slides along the section 214 of the spring 204, pushing the section 214 outward from the notch 193. As the force 238 continues to be applied, the profile 240 pushes the section 214 completely out of the notch 193 unlatching the divider 138 as shown in FIG. 12. As the force 238 continues to be applied, the divider 138 and the housing 181 now move together in the unlatched state until the divider 138 arrives at the desired location. When the force 238 is ends, the force of the spring 204 pushes the section 214 into the new notch 193 and centers it in the unlatching aperture 236 back to the state of FIG. 10. The profile 240 and the shape of the notches 193 may be used to tune the latching and unlatching action including the force required to unlatch and the holding force when latched. For example, adding slope to the walls of the notches 193 decreases holding/retention force of the divider 138. Also for example, adding slope to the profile 240 reduces the force 238 on the divider 138 needed to unlatch.

FIG. 13 shows the area of the housing 181 illustrated in the unlatched state. In the unlatched state, the divider 138 is free to be repositioned, which may also be referred to as an unlocked state. The housing 181 is disposed along the rail 162 and the notches 193 are visible. The housing 181 includes the cavity 202 and contains the spring 204. The spring 204 extends between the two spring supports 206 and 208 on opposite ends of the housing 181. The spring 204 is deflected by the divider 138 and the section 214 is moved out of the unlatching aperture 236. This holds the section 214 out of the notches 193 while the divider 138 and the housing 181 are slidable and glide along the rail system 160 together. As will be understood both housings 182 and 182 operate similarly and slide with the divider 138. As the divider 138 moves its bars 175 and 176 (FIG. 5) also move along the rails 161 and 163 respectively. As will also be understood, the divider 136 operates similarly to the divider 138.

Accordingly, an article holder system provides selectable repositioning of dividers for storage and/or article holding in response to the sole act of applying a force to a divider. The article holder system may be used for storage and/or holding of various objects. A two-stage action with lost motion during unlatching simplifies the requirements for unlatching such that no separate trigger/button is needed to unlatch. The individual features may be provided through various combinations of components with the ability to minimize part count by molding-in or forming components together.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An article holder system, comprising:
an enclosure defining, at least in part, a compartment, wherein the compartment is configured to hold articles;
a divider that defines and separates, at least partly, a first place from a second place within the compartment;
a rail system including at least one rail defined on the enclosure;
a housing coupled between the divider and the rail system; and
a spring carried by the housing, the spring including a section configured to project toward the rail,
wherein the at least one rail includes notches configured to receive the section of the spring to hold the divider in a latched state and the divider includes an aperture configured to move the section of the spring to unlatch the divider.

2. The article holder system of claim 1, wherein the at least one rail comprises at least two rails, both of which include the notches.

3. The article holder system of claim 1, wherein the divider is configured to move a travel distance relative to the housing, wherein the travel distance is approximately equal to an unlatch distance required to move the section out of a respective one of the notches.

4. The article holder system of claim 1, wherein the at least one rail comprises four rails, two of which include the notches and two of which do not include the notches.

5. The article holder system of claim 1, wherein the housing includes a first spring seat and a second spring seat, wherein the spring extends between the first spring seat and the second spring seat, wherein the section of the spring is disposed between the first spring seat and the second spring seat.

6. The article holder system of claim 1, wherein the section of the spring comprises a projection that extends toward the at least one rail.

7. The article holder system of claim 1, wherein the divider is configured to move a travel distance relative to the housing, wherein the travel distance is approximately equal to an unlatch distance required to move the section out of one of the notches, wherein the aperture has a profile that defines the unlatch distance.

8. The article holder system of claim 1, wherein the rail system, the housing and the spring are configured so that the divider is unlatched upon an application of force to the divider and wherein the divider is self-latching upon a cessation of the application of force.

9. The article holder system of claim 1, wherein the housing comprises an I-shaped bar with a section coupling with the divider and a section coupling with the at least one rail.

10. The article holder system of claim 1, wherein the enclosure comprises a removeable insert configured to be received in an interior component of a vehicle.

11. An article holder system, comprising:
an enclosure defining, at least in part, a compartment, wherein the compartment is configured to hold articles;
a divider that defines and separates, at least partly, a first place from a second place within the compartment;
a rail system including a first rail and a second rail, the first and second rails defined on the enclosure;
a first housing coupled between the divider and the first rail;
a second housing coupled between the divider and the second rail;
a first spring carried by the first housing, the first spring including a first section configured to project toward the first rail;
a second spring carried by the second housing, the second spring including a second section configured to project toward the second rail,
wherein the first rail includes first notches configured to receive the first section and the second rail each includes second notches configured to receive the second section to hold the divider in a latched state, and
wherein the divider includes a first aperture configured to move the first section and a second aperture configured to move the second section to unlatch the divider for repositioning.

12. The article holder system of claim 11, wherein the divider is configured to move a travel distance relative to the first and second housings, wherein the travel distance is approximately equal to an unlatch distance required to move the first section out of the first notches and the second section out of the second notches.

13. The article holder system of claim 11, wherein the rail system includes the first rail, the second rail, a third rail and a fourth rail, wherein the third and fourth rails do not include notches.

14. The article holder system of claim 11, wherein the first housing includes a first spring seat and a second spring seat, wherein the first spring extends between the first spring seat and the second spring seat, wherein the first section of the first spring is disposed between the first spring seat and the second spring seat.

15. The article holder system of claim 11, wherein the first section of the first spring comprises a first projection that extends toward the first rail, wherein the second section of the second spring comprises a second projection that extends toward the second rail.

16. The article holder system of claim 11, wherein the divider is configured to move a travel distance relative to the first housing and the second housing, wherein the travel distance is approximately equal to an unlatch distance required to move the first section out of the first notches and the second section out of the second notches, wherein the first and second apertures each have a profile that defines the unlatch distance.

17. The article holder system of claim 11, wherein the rail system, the first and second housings and the first and second springs are configured so that the divider is unlatched upon an application of force to the divider and wherein the divider is self-latching upon a cessation of the application of force.

18. The article holder system of claim 11, wherein each of the first and second housings comprise an I-shaped bar with a first section coupling with the divider and a second section coupling with a respective one of the first and second rails.

19. The article holder system of claim 11, wherein the enclosure comprises a removeable insert configured to be received in a console of a vehicle, wherein the removeable insert is configured as a cupholder.

20. An article holder system for a vehicle, comprising:
an enclosure defining, at least in part, a compartment, wherein the compartment is configured to hold articles;
a divider that defines and separates, at least partly, a first place from a second place within the compartment;
a rail system including a first rail and a second rail, the first and second rails defined on the enclosure;
a first housing coupled between the divider and the first rail;
a second housing coupled between the divider and the second rail;
a first spring carried by the first housing, the first spring including a first section configured to project toward the first rail; and
a second spring carried by the second housing, the second spring including a second section configured to project toward the second rail,
wherein the first rail includes first notches configured to receive the first section and the second rail each includes second notches configured to receive the second section to hold the divider in a latched state,
wherein the divider includes a first aperture configured to move the first section and a second aperture configured to move the second section to unlatch the divider for repositioning,
wherein the enclosure comprises a part of an interior component of the vehicle.
